(19) United States
(12) Patent Application Publication
(10) Pub. No.: US 2013/0021422 A1
(43) Pub. Date: Jan. 24, 2013

(54) INKLESS PRINTING METHOD WITH HEATING PROCESS AND PRINTING HEAD UNIT THEREFOR

(71) Applicants: Jinxiang Chen, Nanjing (CN); Zhishen Wu, Nanjing (CN); Gang Wu, Nanjing (CN); Juan Xie, Nanjing (CN); Fang Chen, Nanjing (CN)

(72) Inventors: Jinxiang Chen, Nanjing (CN); Zhishen Wu, Nanjing (CN); Gang Wu, Nanjing (CN); Juan Xie, Nanjing (CN); Fang Chen, Nanjing (CN)

(21) Appl. No.: 13/639,828

(22) PCT Filed: Jun. 28, 2011
(86) PCT No.: PCT/CN11/76509

§ 371 Date: Oct. 5, 2012

(30) Foreign Application Priority Data
Jun. 30, 2010 (CN) 201010218623.8

(51) Int. Cl. B41J 2/32

(52) U.S. Cl. 347/197

(57) ABSTRACT

An inkless printing method with heating process is disclosed. In the method, a conventional printing paper (15) is used, and a printing head (4,27) contacts the printing paper directly or indirectly. A heating element (13,22) is placed in the printing head(4,27), which provides heat energy to cause a color change in a surface layer of the paper, thereby producing a character or an image. When the printing head (4,27) contacts the printing paper directly, a temperature of the printing head (4,27) is set to 100-1000° C.; and a stagnation time of the printing head (4,27) is set to 0.1-100 ms; when the printing head (4,27) contacts the printing paper indirectly, a temperature of the printing head (4,27) is set to 200-1000° C. The method does not need to use toner, ink or paint, and only needs conventional printing paper (15) and said heating process to achieve printing effect. A printing head unit to be used in said printing method is also disclosed.

### FIELD OF THE INVENTION

The present invention relates to an inkless ecologic printing technique, in particular to a printing method with heating process applicable to printing units, such as office, home, or industrial printers, printing presses, duplicators, fax machines, and all-in-one machines, etc.

### BACKGROUND OF THE INVENTION

As the technology develops and the people's living standard improves, printing devices such as printers have become indispensable office devices of enterprise and public institution and also have become common supplies of many homes.

At present, in addition to 31) printing technology, printers are mainly categorized by the printing principle into four types, i.e., laser printers, inkjet printers, stylus printers, and thermal printers. Wherein, thermal printers are mainly used for label and bar code printing, and stylus printers are mainly used in specific field such as printing bill, while laser printers and inkjet printers are widely used in office, news, and home fields. All of the three types of printers except for thermal printers use ink power or ink, which result in a unsavory smell when it is used. It is reported that the unsavory smell contains a great deal of fine particles, heavy metals, and harmful gases; in particularly, the carcinogens which is known by people, such as benzene, aldehyde, and styrene, etc. The ink power or ink gives off harmful gases not only in the printing process but also in the reading process of new books, especially in the reading process of new newspapers. The hazard of ink still exists even after the printed articles are discarded, and has adverse effect to the production cost of paper recycling and the quality of recycled paper.

In order to eliminate the unsavory smell in the printing process, in the view of the first inventor's experience, who commits himself to ecologic materials research, the present invention is based on the general idea of “inkless printing” is “ecologic printing”. The inventor envisaged a way of printing without ink—“color change of printing paper”—common factors that contribute to color change of printing paper include temperature, humidity, light, and time, etc., except for adding chemicals for color change; in addition, through preliminary verification, the inventor has found that a printing effect with use value can be attained by heating process printing method, as long as long as the major technological parameters such as temperature and contact time of paper (printing speed) are controlled! Thus, the present invention provides an inkless ecologic printing method, i.e. heating process printing method, in which ink power or ink is not required for printing.

Existing printing techniques that are similar to the heating process printing method include thermal printing technique and pyrography method. Hereafter the general principles and present situation of these techniques will be introduced first; then, the inventiveness of the present invention will be detailed by comparison.

The working principle of thermal printer is: a semiconductor heating element is mounted on the printing head; after receiving the data to be printed, the thermal printer switches the data to be printed into bitmap data, and then controls the current through the heating element in the printing head according to the dots of the bitmap data; the printing head heats up and comes in contact with the thermal printing paper, heats up certain positions on the thermal sensitive paper selectively, so that the coating on the thermal sensitive paper has chemical reaction and changes color to expose the required images and letters; in that way, the data to be printed is converted to the printed content on the printing paper. The heaters in the printing head are aligned into a square dots or strip form, and are controlled logically by the printer; when they are driven, a image that corresponding to heating element is produced on the printing paper. The same logic circuit controls both of the heating element and the paper feeding, and thereby can print out images on the entire label or paper.

Rice paper pyrography method: In all pyrography methods, rice paper is a material that is the most similar to the printing paper of the present invention (other materials include bamboo and wood, etc.). Therefore, the invention patents related with rice paper pyrography method in the last few years will be introduced here. The typical main technical process is: spray or brush a layer of thin pulp material made of a variety of chemical materials on a flattened rice paper, iron the layer of thin pulp material with a steam iron to make it set, after airing the paper, draw on the paper with an electric iron pen. It is reported that the process is simple and easy to operate, and it is very convenient to draw on rice paper with an electric iron pen.

Inkless ecologic printing method: from ancient times, literatures were mainly produced in following two methods 1) engrave with a rigid cutter (or iron with an iron pen) on thick plates such as bamboo, stone and bone, etc.; 2) paint (write) with a material in one or more colors (e.g., black ink) on a substrate material in a different color (e.g., white paper). If the former is referred as “engraving method” and the latter is referred as “painting method”, the existing printers can be categorized into engraving machines and pyrographing machines (though they are not called as printers) and 3D printers (though they employs a principle reversed to engraving: overlap layer by layer), which utilize engraving method, and inkjet printers, laser printers and stylus printers, which utilize painting method, following the traditional habituation thought. Techniques connected with painting method principle include thermal printer and rice paper pyrography method—they require compounding thermal color changing materials on printing paper in advance, or spraying or brushing a thin pulp material on a rice paper. That is to say; they also produce letters or images by painting (writing) with a material or thin pulp material in one or more colors on a substrate material in a different color. The only difference is: such “painting (writing)” process is accomplished by allowing the foresaid material or thin pulp material to change color by thermal energy. All of them employ two types of materials: “color material” or “thin pulp material” and “substrate material”; therefore, essentially, they belong to a printing or pyrography method that adding a special “material” on a “substrate material”.

The present invention completely breaks through the limit of traditional habituation thinking as mentioned above: despite in people's impression, printing paper is quite thin and is an inflammable material: when exposed to fire, printing paper will be burnt, and even sparks (e.g., charcoal flame and cigarette ash in daily life) will cause burnt holes on ordinary paper when they fall onto the paper. However, experiments have shown that an expected printing effect can be attained by heating on a single ordinary printing paper; i.e., only a single “substrate material” is required. Compared to the traditional printing methods, which require at least two kinds of materials for printing, the heating process requires only one kind of material (i.e., a piece of printing paper) to accomplish printing. That is a great leap from quantitative change to qualitative change—as the various kinds of material components are gradually reduced to zero, the present invention is achieved. In other words, “the recipe of color materials in the present invention is a very special case: all material components are zero, which is an ecologic material recipe that has the best low-carbon and energy-saving features”.

### SUMMARY OF THE INVENTION

In order to provide a safe and comfortable living environment and seek out an ecologic printing method without environmental pollution, one object of the present invention is to provide a printing method with heating process that doesn't require ink power or ink and specific printing paper, so as to overcome the drawbacks in the prior art; another object of the present invention is to provide a printing head unit used in the above-mentioned method. They fill up a gap in the prior art, and belong to an inkless ecologic printing technique, which can solve the fore-mentioned environmental pollution problems. The present invention has bold conception, a clear application field, and features with ecological and environmental protection, and convenient for industrialized manufacturing, etc.

To attain the first object described above, the following technical scheme is employed in the present invention:

An inkless ecologic printing method with heating process, which uses conventional printing paper, and a printing head contacts directly with the printing paper or doesn't contact directly with the printing paper, wherein, a heating element is mounted on the printing head, and the surface layer of the printing paper changes color by heat energy from the printing head, thereby letters or images is produced; in the case of direct contact, the temperature of the printing head is set to 100-1000° C., and the residence time of the printing head is set to 0.1-100 ms; in the case of indirect contact, the temperature of the printing head is set to 200-1000° C., and the residence time of the printing head is set to 0.1-100 ms.

In the case of direct contact, the temperature of the printing head is set to 400-600° C., and the residence time of the printing head is set to 0.2-50 ms. Based on a large number of experimental results, when the temperature is lower than 400° C. (e.g., 350° C.), though the printing paper can change color, it requires longer contact time (residence time of the printing head). Therefore, it has little practical effect for existing ordinary printing paper; when the temperature is higher than 600° C. (e.g., 800° C.), at this time, the printing head will be easily in a red glow state, and the printing paper may be burnt out in the case of manual operation; therefore, printing at such a high temperature is not appropriate in view of safety, or a higher safety protection technique is required. Thus, usually 600° C. is preferably as the upper limit of heating temperature. The residence time of the printing head is determined with the clicking method according to example by obtaining the number of click points within a schedule time and estimating the time percentage of clicking contact time thereof in each of the clicking action process, plus appropriate allowance, with reference to the situation of existing stylus printers.

Said elements that contact with the printing paper in the printing head are printing styluses or printing dot matrix.

Said heat energy from the printing head turns the surface layer of the printing paper to yellow or black color due to carbonization.

The heating element in the printing head has an attemperation unit; different printing effects can be obtained by designing different heating element, heating temperature, residence time of printing head, and corresponding paper feeding speed.

The printing method provided in the present invention is an inkless ecologic printing method with heating process, which is based on the technique principles of existing thermal printers and stylus printers, and supply energy to a heat printing head by energy supply unit, so that the heat printing dot matrixes or heat printing styluses in the printing head obtain corresponding thermal (optical) energy, and then transfer energy to a printing paper to be typed by heat conduction (including conduction, radiation, and heat release, etc.) or optical conduction, to turn the surface layer of the corresponding printing paper to yellow or black color (high temperature) due to carbonization (color change) by heat energy, and thereby produce required letters or images. The printing method doesn't require ink power, ink or paint; and only needs conventional printing paper and through heating process to achieve printing effect.

The present invention employs the following technical scheme in order to solve the second technical problem in the present invention:

A printing head unit, including an armature, a printing stylus, a driving mechanisms, a offsetting spring, a support plate, and a guide plate, wherein, the printing stylus passes through the support plate, the upper end of the printing stylus is fixed on the armature, and the printing movement of the printing stylus is implemented by the driving mechanism and offsetting spring; wherein, the printing head further includes a heating element, which is used for heating the printing styluses.

Said driving mechanism is a drive coil or actuating arm, with an iron core mounted in the drive coil.

Said heating element is a thermistor, with printing stylus guide holes arranged on it; the thermistor is fixed on the printing styluses and heat up each of the printing styluses collectively.

Said heating element is individual heating apparatus, each of which corresponds to one printing stylus respectively.

Said Drive coil is an oval shape coil, which is a single layer coil or double layers coil; when employs double layers coil, the printing stylus passes through the support plate from its root, passes directly through dead center position of the corresponding hole in the support plate without contact with the support plate.

The present invention has the following beneficial effects:

The present invention breaks through the limit of traditional habituation thinking, and attains required printing effect by heating process to change color of the surface layer of printing paper. Therefore, the present invention changes the traditional way of printing thoroughly. No harmful gas that contains heavy metals and organic high polymers in ink power or ink will emit in the entire life cycle of the product, from the start of printing, to use and storage of printing articles, as well as recycle of discard articles. The present invention completely eliminates a series of problems caused by ink power or ink, such as environmental pollution and human health hazards, etc.; on the other hand, since no ink supply unit (system) is required and the printing process is simple, the printing devices can be more compact in structure and lighter in weight. Moreover, since no ink power or ink is used, the scale of production in the entire ink power or ink industry will be reduced greatly. Therefore, the present invention is an inkless ecologic printing method and is a truly green and environment-friendly product, with excellent low-carbon and energy-saving effect and social benefits. The present invention can be widely used in a variety of printing units, including the printers described above, and therefore can be used to produce a variety of inkless ecologic printing units with heating process. Since no ink power or ink is used, the structure and process are simply; thus, 1) no ink power or ink is consumed in the printing process—only the energy required for heating process is required, and therefore the printing is easy to use and manage; 2) a variety of processing costs required in ink removal in the waste paper recycling process can be reduced greatly, and in favor of improving the quality of recycled paper. Therefore, compared with conventional printing units, a printing unit in the present invention not only has reduced energy consumption and cost in the entire life cycle of the product, but also is an environment-friendly and green product, which can be used in places such as offices and homes trustingly. The general idea of the present invention is bold and clear, the feasibility of the method is proved. Combining with the existing printing technology, the method provided in the present invention can be used to produce printing units such as inkless ecologic printer with heating process; in addition, such printing units are easy to industrialized manufacturing, and are expected to replace part of existing various monochromatic printing units once they are introduced into the market, and thereby bring great economic benefits.

### BRIEF DESCRIPTION OF THE DRAWINGS

FIG. 1 is a schematic flow chart of a contact printing method with heating process.

FIG. 2 is a schematic structural diagram of the core portion of a stylus printing head with heating process.

FIG. 3 are schematic structural diagrams of two stylus printing heads with heating process in different heating forms, wherein, FIG. 3a shows collective heating with a thermistor plate, and FIG. 3b shows respective heating of each styluses.

FIG. 4 shows the coil structure of a circular stylus printing head with heating process, wherein, FIG. 4a is a single layer coil, FIG. 4b is a double layers coil, and FIG. 4c shows the layout condition of stylus guide holes on the positioning plate and stylus guide plate.

FIG. 5 shows the structure of a single layer coil in an oval shape stylus printing head with heating process, wherein, FIG. 5a is a top view, and FIG. 5b is a side perspective view (the armatures for most of the printing styluses are shown partially).

FIG. 6 is a schematic diagram of a thermal printing head.

FIG. 7 shows a stylus printing head with heating process that employs oval double coils for collective heating, wherein, FIG. 7a is a top view, and FIG. 7b is a side perspective view.

FIG. 8 shows a sty his printing head with heating process that employs oval double coils for respective heating, wherein, FIG. 8a is a top view, and FIG. 8b is a side perspective view.

FIG. 9 shows a mechanical drive mode for stylus printing styluses.

FIG. 10 shows the results of simulated manual printing with heating process (clicking type), wherein, FIG. 10a: 350° C., and FIG. 10b: 480° C.

FIG. 11 shows the results of simulated manual printing with heating process (writing type), wherein, FIG. 10a: 350° C., 75s; FIG. 10b: 480° C., 28s; FIG. 10c: 480° C., 60s.

### BRIEF DESCRIPTION OF THE REFERENCE NUMBERS IN FIGURE

1. Data to be printed, 2. Energy supply, 3. Electromechanical control, 4. Printing head with heating process, 5. Printing action, 6. Paper feeding action, 7. Post-treatment, 8. Stopper, 9. Printing stylus with heating process, 10. Positioning plate, 11. Guide plate, 12. Heat insulating plate, 13. Heating plate, 14. Front end heat insulating plate, 15. Printing paper, 16. Winding drum, 17. Iron core, 18. Drive coil, 19. Gasket, 20. Armature, 21. Stylus offsetting spring, 22. Individual heating element, 23. Circular single layer coil, 24. Circular double layers coil, 25. Stylus guide hole, 26. Oval single layer coil, 27. Thermal printing head, 28. Printing dot matrix, 29. Oval double layers coil, 30. Independent heat insulating plate, 31. Actuating arm.

### DETAILED DESCRIPTION OF THE EMBODIMENTS

Hereafter the embodiments of the present invention will be explained in detail, with reference to the accompanying drawings.

The procedure of contact printing with heating process is shown in FIG. 1. It inherits the basic procedures of existing printing methods, including print data transfer 1, energy supply 2, mechanical control system 3, printing head 4, printing head movement process 5, and printing paper (paper feed unit), etc. However, the core of the present invention employs an inkless printing method with heating process, and the printing head employs the following combination of heating process temperature, contact time, and contact pressure:

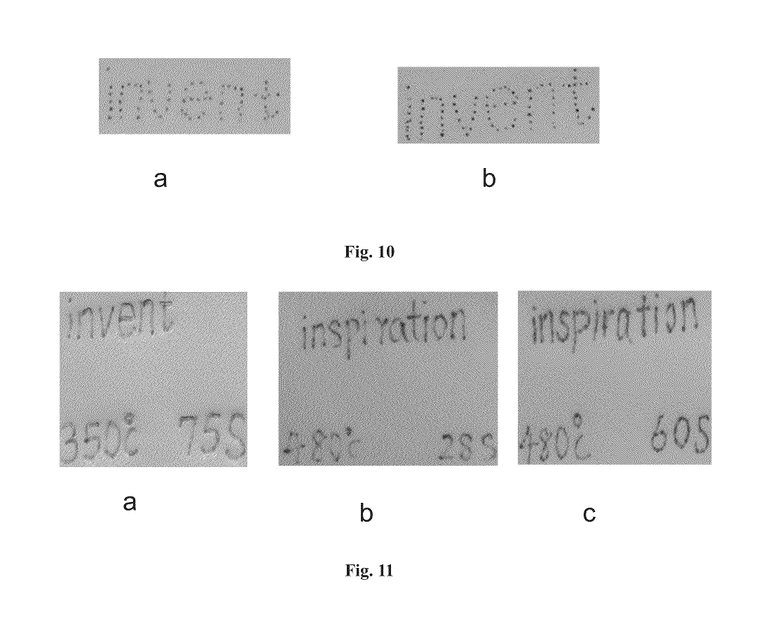

Preferably, with combination of energy supply intensity (heating process temperature), contact time of heating process printing dot matrixes or heating process printing styluses with paper (printing speed), and contact pressure, a good printing effect can be obtained, and it ensures that the printing paper remain enough strength. The results of simple manual experiments have proved that conception (see FIGS. 10 and 11).

Preferably, the heating process printing dot matrixes or heating process printing styluses in the printing head directly or indirectly contact with the printing paper; in the case of direct contact, the temperature of the heating process printing dot matrixes or heating process printing styluses in the printing head is set to 400-600° C., and the contact time is set to 0.2-50 ms.

As a further improvement, in the case of direct contact, the maximum temperature of the heating process printing dot matrixes or heating process printing styluses in the printing head can be set to 600-800° C. and the contact time can be set to −20 ms to achieve high-speed printing.

In particular, to attain a purpose of yellowish printing effect or to attain the purpose of energy conservation, the existing printing paper can be modified for the heating process printing technique disclosed in the present invention, so that it can have function of turning to yellow color above a certain temperature (e.g., above 150° C.); in that case, the temperature of the heating process printing dot matrixes or heating process printing styluses in the printing head can be set to 150-400° C. and the contact time can be set to 1-50 ms in the case of direct contact.

In the case of indirect contact, usually direct laser irradiation printing is utilized; in that case, the temperature of paper surface is set between 200-800° C. by controlling the function of laser.

Optionally, after the heating process printing process is finished, high-speed air cleaning treatment or sealing wax treatment can be carried out, or both of them can be carried out in combination.

In particular, a certain contact dent can be formed by adjusting the contact pressure and thereby a special slight 3D printing effect can be obtained, in the case of contact heating process printing.

Printing method based on two different basics:

Preferably, the printing method is implemented by innovation based on existing stylus and thermal printer technique principle:

Implement based on the existing stylus printer technique: one method is: produce the corresponding parts using high-temperature resistant materials, heat up the tips of the printing styluses of the stylus printer collectively by means of a heating plate (e.g., a heating plate produced by thermistor), and thereby implement printing. Another method is: energize each stylus through a series connection or parallel connection to heat up the printing styluses and thereby implement printing.

Innovation implement method based on thermal printing technique is: produce printing dot matrixes using high-temperature resistant thermistor on a Kyocera thermal printing head, and strengthen the heat insulation effect between the printing dot matrixes and the substrate, to prevent the substrate from burnt at high temperature; specifically, that purpose can be attained by adding a heat insulation layer or producing novel structure which has hollow layer.

As a further improvement, said heating element in the printing head has a thermistor-based temperature control unit that controls the temperature of the heating process printing dot matrixes or heating process printing styluses in the printing head, and is provided with corresponding automatic control unit such as alarm unit, overload protection unit, low-temperature standby unit, etc.

To improve the overall printing speed of the entire printer, multiple printing heads that are separated from each other physically or a printing head that integrates multiple printing heads can be employed.

The following technical scheme is employed in the present invention in order to implement the second object described above:

A printing head unit that employs the method described above. According to the characteristics of heating process printing technique, the second purpose of the present invention is attained by improving the printing head on the basis of the existing stylus printer technique and thermal printing technique. The improvement scheme based on stylus printing technique is as follows: first, high-temperature resistant materials is used to produce the printing styluses and peripheral parts thereof; second, a stylus heating unit and an corresponding automatic control unit are added; third, to prevent heat loss and prevent the printing paper from burnt by pinheads that are not used in printing, a thermal insulating unit is arranged around the printing head and on the apex of the printing head; fourth, the stroke of the printing pinheads is increased by adjusting the size and relative positions of the drive coils, offsetting springs, and armatures in the printing head; fifth, the color strip and color strip baffle are removed, so that the apex of the printing head contacts with the printing paper directly in the printing process. The improvement scheme based on thermal printing technique is as follows: first, printing dot matrixes is produced with a high temperature thermistor; second, a corresponding heat insulating unit is arranged to protect the substrate from burnt.

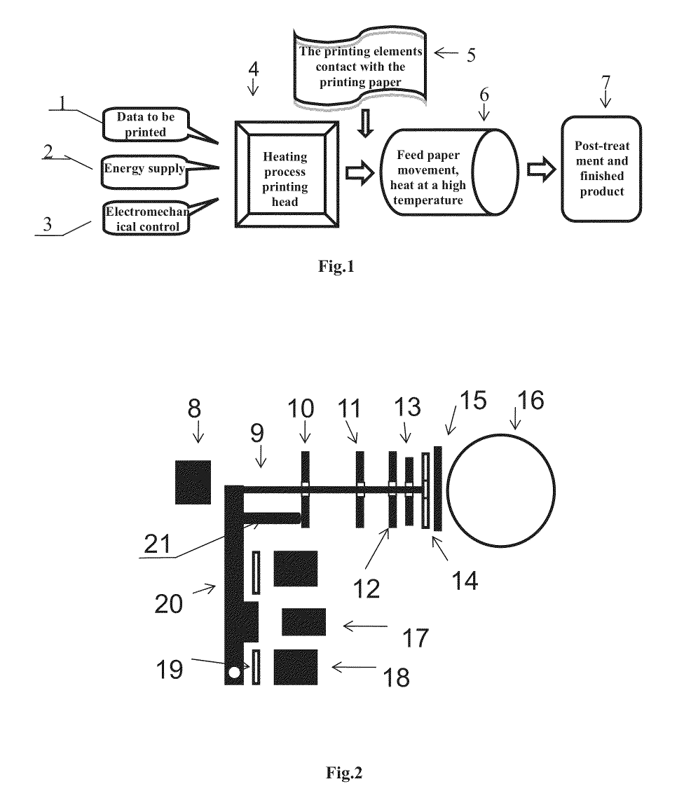

The basic structure of the core part of a heating process printing head innovated on the basis of stylus printing technique is shown in FIG. 2.

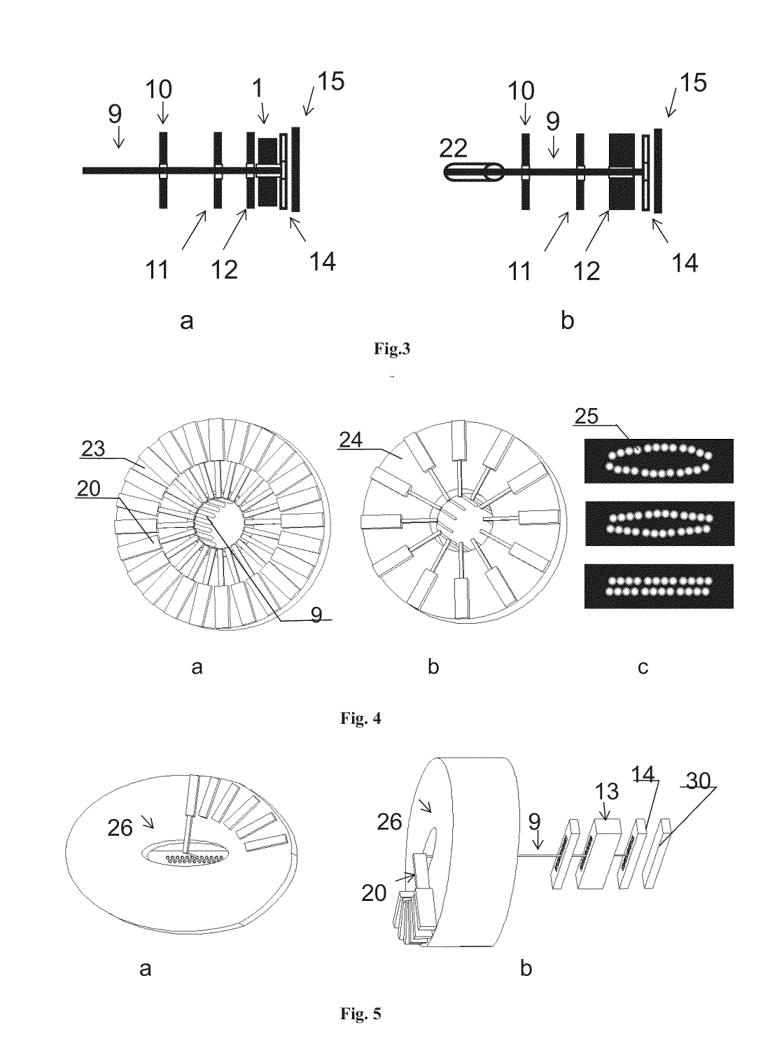

There are two heating methods for the heat printing styluses on the basis of the existing stylus printing technique: one method is: add a heating plate 13 shown in FIG. 3 to heat up the tips of the printing styluses in a stylus printer collectively. The second method is: energize each printing stylus through a series connection or parallel connection to heat up the printing styluses.

As shown in FIG. 4, a printing head that is based on the existing stylus printing technique can employ a circular single layer coil structure or double layers coil structure of the existing stylus printers firstly. In addition, the oval shape single layer coil structure and double layers coil structure 24 in the present invention can also be provided.

The length of printing styluses can be the same as the length of printing styluses on existing stylus printers, i.e., in 10-50 mm; preferably, the optimum length is 10-30 mm, combining with the characteristics of heating process printing technique.

Improvement implement based on thermal printing technique: produce printing dot matrixes with a high-temperature resistant thermistor on a Kyocera thermal printing head, and strengthen the heat insulation between the printing dot matrixes and the substrate so as to prevent the substrate from burnt at high temperature; specifically, it can be attained by adding a heat insulation layer or producing novel structure which has hollow layer.

To improve the printing speed, multiple printing modules can be integrated on one printing head. Or, multiple printing heads, each of which handles an area in left-right direction respectively, can be employed.

Preferably, the heating element in said printing head has an attemperation unit; different printing effects can be obtained by designing different heating element, heating temperature, and matched corresponding paper feeding speed.

In the case of indirect contact, laser printing is mainly employed. Concrete irradiating power appropriately to attain a good printing effect.

In particular, heating process printing can be implemented with one of the electric discharging technique or fire-breathing technique, or a combination thereof.

As an extended application, the printing method is also applicable to printing machineries, since they employ the same basic principle.

### Example 1

### Proving of Feasibility of the Method: Simulated Manual Heating Process Printing Instance

Use a controllable hair-line heating element, after its temperature is controlled at a setting temperature between 350° C. and 800° C., and the partial results of simulate heating process printing manually on a piece of ordinary printing paper are shown in FIG. 10 and FIG. 11. Wherein, the result shown in FIG. 10 is obtained by clicking mode. Clicking mode is similar to the actual printing action in a printer. However, in view that it is difficult to connect each point smoothly without overlap into one piece by manual operation, a result obtained by writing mode is provided in FIG. 11.

It can be seen from FIG. 10 and FIG. 11: no matter which method is used, the letters or figures printed out by simulated manual heating process printing are clear. The clicking mode printing result shown in FIG. 10 looks pale because the points are dispersed and there are too many peripheral white spaces; however, during mechanical printing, these points can be connected to form strokes, just like the case of printing from an ordinary printer. As shown in FIG. 11, though the printing result is not in pure black but in golden yellow, the letters are distinguishable clearly enough as a printing effect; in addition, no fading phenomenon is seen after 3 months. Therefore, the printing unit can be used in practical applications without any problem, especially when it is used as a printing device for temporary document. Moreover, a better printing effect can be obtained correspondingly through improvement of a definite period research. Thus, the feasibility of the method disclosed in the present invention is proved in principle.

In addition, the control of grayscale of printed letters can be achieved by adjusting the temperature of heating element, printing speed, and contact pressure. As shown in FIG. 10 and FIG. 11, usually the grayscale is low with yellow tint at lower temperature (as shown in FIG. 10a and FIG. 11a), and the grayscale is high with black tint at higher temperature (as shown in FIG. 10b and FIG. 11b). Thus, a printing method with different technical conditions and different printing effects can be designed by means of different combinations of temperature, printing speed, and contact pressure of heating element.

### Example 2

### Contact Heating Process Printing Method (Example Based on Principle)

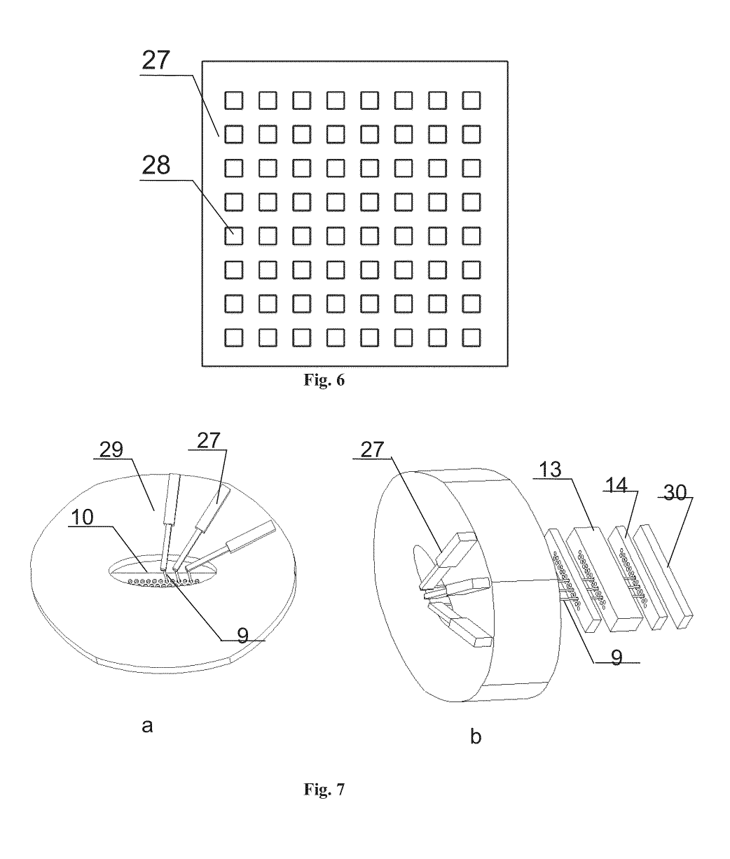

The procedure of contact heating process printing method is shown in FIG. 1. It inherits the basic procedures of existing printing methods, including a print data transfer 1, a energy supply 2, a electromechanical control system 3, a printing head 4, a printing head movement process 5, and a printing paper (paper feed unit), etc. However, innovations are made to the printing head. The method includes: heating-up procedure of the heating element, action of correlation parts contact with the printing paper, and color change of surface layer of printing paper at high temperature and formation procedure of letters or images. The printing heads can be divided into two large types, they are printing heads which according to existing stylus printer and thermal printer respectively, produced by adding high-temperature thermistor and temperature control unit etc., then combining printing method in the present invention and carry out corresponding technology improvement. The heating elements in the printing heads that contact with the printing paper, the former is referred to as heating process printing stylus (reference number 9 in FIG. 2), and the latter is referred to as heating process dot matrix (reference number 28 in FIG. 6). The heating mode of heating process dot matrix is the same as that of existing thermal printers, i.e., only the dot matrix required in the printing has to be heated up. Whereas, in the case of heating process printing styluses, the heating process printing styluses can employ the same heating mode as the styluses in existing thermal printers, or heated up collectively before the printing cycle, and then the heating process printing styles required in the printing cycle are driven to contact with the printing paper while the rest printing styluses are kept at their original positions. The recommended optimum printing temperature is 500-600° C.

### Example 3

### A Stylus Heating Process Printing Head in which the Styluses are Heated Up Together

FIG. 7 is a schematic structural diagram of the core part of a double-coils stylus heating process printing head unit in which the styluses are heated up together. The basic structure and principle thereof is similar to the double-coils stylus printing head shown in FIG. 4b, with the following improvements: first, high temperature resistant materials is used; second, as shown in FIG. 4a, the printing stylus pass from root through the dead center position of corresponding hole in the positioning plate 10 directly, without contact with the positioning plate, while the printing stylus in any existing printer requires to contact with the positioning plate when it passes through the corresponding hole, and thus the circular layout of styluses originally as shown in FIG. 5a is changed to parallel layout in two rows of styluses after the top-down guide of the positioning plate or guide plate shown in FIG. 5C; a thermistor plate 13 shown in FIG. 5b is added to heat up the tips of all printing styluses together. Then, according to the data information to be printed, the ingress and egress of the styluses is controlled to accomplish the printing process. Since the tips of the styluses in the printing process are both at a high temperature, therefore, a heat insulating plate 14 is required to achieve heat insulation. When there is no printing task, most front end of the styluses tips must be kept at a certain distance (usually 1-2 mm) to the printing paper, or a heat insulating plate 15 with holes (holes are not drawn in the Figure) that can be opened automatically as the printing styluses are actuated has to be added between the heat insulating plate 14 and the printing paper. With such a structure, not only heating process printing can be accomplished, but also the printing styluses don not contact with the positioning plate or guide plate, so the length of printing styluses can be shortened appropriately (30 mm maximum length is enough). With such a structure, the friction between the stylus printing and the inner surface of hole is avoided, and therefore energy-saving effect can be attained, and the service life of the printer can be prolonged. By the way, it is noted that only one layer of coil and the distribution of a quarter of the styluses are shown in FIG. 7.

### Example 4

### A Stylus Heating Process Printing Head in which the Styluses are Heated Up Separately

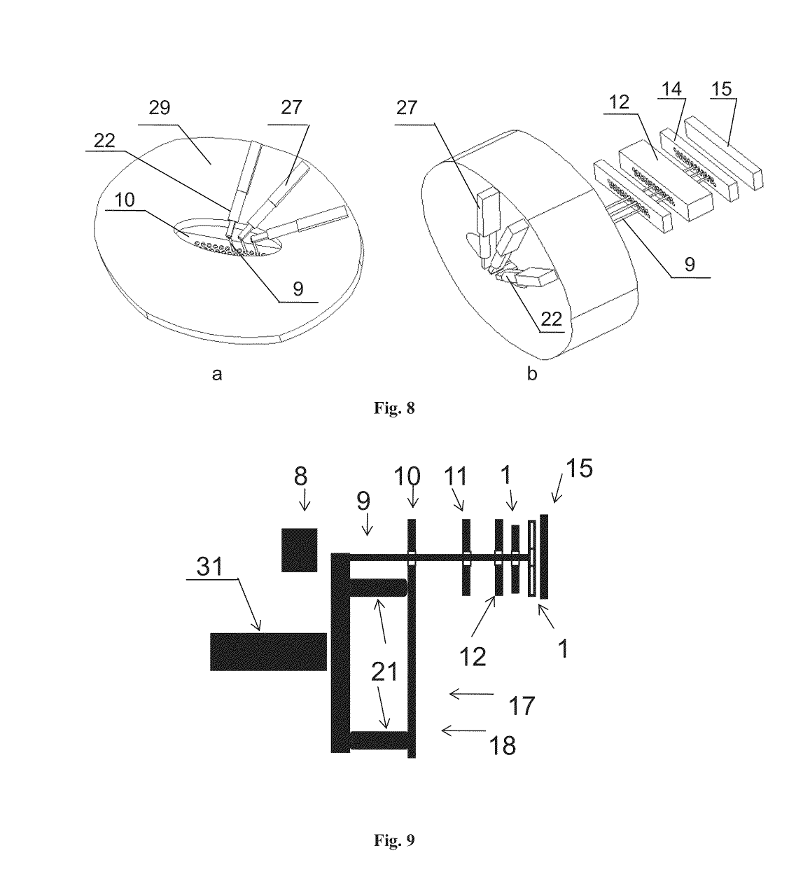

FIG. 8 is a schematic structural diagram of the core part of separate double-coils stylus heating process printing head of the printing styluses. The basic structure and principle thereof is similar to that shown in FIG. 7, with the following improvements: the collective heating plate 13 is replaced with a heat insulating plate 12, each printing stylus itself can be energized to heat up, and thus only the printing styluses required in the printing cycle are heated up and are driven to accomplish printing action, according to the data information to be printed. In that case, the temperature of the printing styluses that are not involved in the printing cycle will cool down; thus, compared to the mode of collective heating, the requirement for heat insulation is lower. When there is no printing task, the front end of the styluses tips also have to be kept at certain distance (usually 0.2 mm) to the printing paper.

### Example 5

### Some Options of Stylus Heating Process Printing Unit

First, the printing styluses can be driven with actuating arms 31 shown in FIG. 9 instead of magnetic force driving mode used in the prior art. The actuating arm can be implemented with a cam machine that can produce periodicity movement and wabbler mechanism to move. Second, in the examples 3 and 4 described above, a new oval double-coils printing head structure is employed. Actually, the original circular double-coils printing head structure can be used, or a single-coil printing head structure can be used directly in combination with the improvement for heating process technique in examples 3 and 4, can also obtain corresponding heating process printing heads respectively; moreover, the printing head can have 72 or 144 styluses, with reference to the existing stylus printers; to improve the printing speed, multiple printing heads can be employed simultaneously (1-6 printing heads are preferred). Multiple printing heads, each printing head handles an area in left-right direction respectively.

### Example 6

### An Illustration of Thermal Heating Process Printing Unit

At present, NTC (Negative Temperature Coefficient) materials (i.e., thermistor phenomena and materials with negative temperature coefficient, the resistance of which decreases exponentially as the temperature increases) are applicable up to 1000° C. or a higher maximum temperature. Therefore, the basic process of heating process printing that is based on thermal printing technique also comprises basic elements of thermal printing, including a print data transfer 1, an energy supply 2, an electromechanical control system 3, a printing head 4, and a movement process of printing head 5, a printing paper(paper feed unit 6 and so on as shown in FIG. 1. The basic structure and electrical control of a printer that is related with these procedures can be directly implemented with the continuous using of existing technique of Kyocera thermal printers. However, the printing head (see FIG. 6) must be renovated as following specific action policy: produce printing dot matrixes with a high-temperature resistant thermistor on a Kyocera thermal printing head, and strengthen the heat insulation between the printing dot matrixes and the substrate, to prevent the substrate from burnt at high temperature; specifically, that purpose can be attained by adding a heat insulation layer or producing novel structure which has hollow layer. Owing to the fact that all printing dot matrixes in the printing head contact directly with the printing paper in a thermal printer, for existing ordinary printing paper, the temperature is set to 500-600° C. for printing dot matrixes that is heated up and 300° C. or lower for printing dot matrixes that isn't heated up.

### Example 7

### Post-Treatment Method

Depending on the different requirement for printing quality, after heating process printing, the heating process result can employ a different post-treatment method. For example, it can be cleaned by high-speed air blasting, or sealing with wax, or no treatment is carried out. Or, air blasting and wax sealing can be carried out in combination.

### Example 8

### Contactless Printing Method

The heating process printing styluses doesn't contact with the printing paper directly; instead, heating process printing is accomplished by means of radiation, convection, heat conduction, or laser, etc. The contactless spatial distance is usually controlled at 0.1˜5 mm, and the temperature can be controlled at 300-800° C. It also can be controlled by controlling the emitting power of the laser.

### Example 9

### Embodiment of Heating Process Printer

The basic printing process and basic structure of the heating printer are shown in FIG. 1, and comprise a print data transfer 1, an energy supply, an electromechanical control system 3, a printing head (movement) 4, and a printing paper (paper feed unit) 5, etc. The printing head employs the printing head structure of stylus printer shown in FIG. 7; before the printing process, the 24 printing styluses are heated up to 600° C. collectively, and each heating process printing stylus can extend and retract as required. The data received by the printer is converted to control the movement of printing styluses; when driven by the control unit, the corresponding printing styluses in the printing head contact with the printing paper and change the surface layer color of in the corresponding position by means of thermal energy (high temperature), and produce a figure that corresponding to heating element, thereby forming letters or images. Controlling the same logic circuit of the heating element as well as the paper feeding 5, and thereby can print out figures on the entire paper.

1. An inkless ecologic printing method with heating process, which uses ordinary printing paper and accomplishes printing with a printing head that direct or indirect contacts with the printing paper, wherein, the printing head has a heating element, and the surface layer of the printing paper changes color by means of heat energy from the printing head, so that letters or images are formed; in the case of direct contact, the temperature of the printing head is set to 100-1000° C., and the residence time of the printing head is set to 0.1-100 ms; in the case of indirect contact, the temperature of the printing head is set to 200-1000° C., and the residence time of the printing head is set to 0.1-100 ms.

2. The heating process printing method according to claim 1, wherein, in the case of direct contact, the temperature of the printing head is set to 400-600° C., and the residence time of the printing head is set to 0.2-50 ms.

3. The heating process printing method according to claim 2, wherein, said elements that contact with the printing paper in the printing head are printing styluses or printing dot matrixes.

4. The heating process printing method according to claim 3, wherein, said heat energy from the printing head turns the surface layer of the printing paper to yellow or black due to carbonization.

5. The heating process printing method according to claim 4, wherein, said heating element in the printing head has an attemperation unit; different printing effects can be obtained by designing different heating element, heating temperature, residence time of printing head, and matched corresponding paper feeding speed.

6. A printing head unit that utilizes the heating process printing method according to claim 1, including armatures, printing styluses, driving mechanisms, offsetting springs, a support plate, and a guide plate, wherein, the printing styluses pass through the support plate, the top end of the printing styluses are fixed to the armature, and the printing movement of the printing styluses are implemented by the driving mechanism and offsetting spring; wherein, the printing head further includes a heating element designed to heat up the printing styluses.

7. The heating process printing head unit according to claim 6, wherein, said driving mechanism is a drive coil or actuating aim, with an iron core arranged in the drive coil.

8. The heating process printing head unit according to claim 7, wherein, said heating element is a thermistor, with printing stylus guide holes arranged on it, and the thermistor is fitted on the printing styluses and heat up each of the printing styluses collectively.

9. The heating process printing head unit according to claim 7, wherein, said heating element is an individual heating devices, each of which corresponds to a printing stylus respectively.

10. The heating process printing head unit according to claim 7, wherein, said drive coil is an oval shape coil, which is a single layer coil or double layers coil; in the case of double layers coil, the printing stylus passes from its root through the dead center position of the corresponding hole in the support plate directly without contact with the support plate.

11. The heating process printing method according to claim 1, wherein, said elements that contact with the printing paper in the printing head are printing styluses or printing dot matrixes.

12. The heating process printing method according to claim 11, wherein, said heat energy from the printing head turns the surface layer of the printing paper to yellow or black due to carbonization.

13. The heating process printing method according to claim 12, wherein, said heating element in the printing head has an attemperation unit; different printing effects can be obtained by designing different heating element, heating temperature, residence time of printing head, and matched corresponding paper feeding speed.

14. The heating process printing head unit according to claim 6, wherein, said heating element is a thermistor, with printing stylus guide holes arranged on it, and the thermistor is fitted on the printing styluses and heat up each of the printing styluses collectively.

15. The heating process printing head unit according to claim 6, wherein, said heating element is an individual heating devices, each of which corresponds to a printing stylus respectively.
